(19) United States
(12) Patent Application Publication
(10) Pub. No.: US 2025/0149042 A1
(43) Pub. Date: May 8, 2025

(54) SPEECH-TO-TEXT CAPTIONING SYSTEM

(71) Applicant: XanderGlasses, Inc., Somerville, MA (US)

(72) Inventor: Alexander G. Westner, Somerville, MA (US)

(21) Appl. No.: 18/825,756

(22) Filed: Sep. 5, 2024

Related U.S. Application Data
(60) Provisional application No. 63/551,720, filed on Feb. 9, 2024.
(60) Provisional application No. 63/547,279, filed on Nov. 3, 2023.

(51) Int. Cl. G10L 15/26; G02B 27/01

(52) U.S. Cl. CPC G10L 15/26; G02B 27/017; G02B 2027/0178

(57) ABSTRACT

An integrated system provides real-time speech-to-text captioning. The system includes an eyewear component comprising an eyewear frame, one or more microphones, a sensor, a display system, a wireless transceiver, and a processor. The eyewear component captures audio using the microphones and detects when the wearer is speaking using the sensor. The processor receives audio from the microphones, determines if the audio is from the wearer speaking, and transmits non-wearer audio to an eyewear case component for speech-to-text conversion. The eyewear component receives the speech-to-text conversion from the eyewear case component and displays it in the wearer's field of view using the display system. The eyewear case component includes a case housing, a wireless transceiver, at least one microphone, and a processor. The eyewear case component receives audio from the microphone, performs speech-to-text conversion on the received audio data, and transmits the text data to the eyewear component.

### CROSS-REFERENCE TO RELATED APPLICATION(S)

This application claims priority to, and the benefit of, co-pending U.S. Provisional Application 63/547,279, filed Nov. 3, 2023, and U.S. Provisional Application 63/551,720, filed Feb. 9, 2024, for all subject matter contained therein. The disclosures of said provisional applications are hereby incorporated by reference in their entirety.

### FIELD OF THE INVENTION

The present invention relates to the field of assistive technology, specifically to an integrated system comprising Extended Reality (XR) eyewear and a computational case, designed to provide real-time speech-to-text captioning for individuals with hearing challenges.

### BACKGROUND

Individuals with hearing challenges often encounter difficulties in understanding verbal communication, especially in noisy or multi-speaker environments. While existing hearing aid technologies continue to advance, they often fall short regarding speech comprehension, due to the complex nature of hearing loss and the variety of challenging listening environments. These audio processing technologies primarily focus on amplifying sound, which may not necessarily improve comprehension, especially for individuals with more severe to profound hearing loss. Therefore, there is a demonstrable need for innovative solutions beyond auditory processing.

People with hearing loss already rely on their sense of vision to read captions while watching TV and movies, and when communicating via video and telephone calls. With extended reality eyewear systems, it is now possible for people to also benefit from captions during in-person conversations. “Captioning glasses” have emerged as a promising solution, leveraging visual cues to supplement auditory information. By transcribing spoken words into text and displaying them in the user's field of view, captioning glasses can significantly enhance communication comprehension.

However, achieving seamless and accurate real-time transcription necessitates robust processing and data communication systems. While the trend in XR product development has been to offload such processing to tethered smartphones, this approach has its limitations. Smartphones are multifunctional devices that receive phone calls, run background processes, and generate notifications-all of these tasks are unpredictable and compete for the same resources needed by the captioning system. Battery life can be quickly depleted when tethered to smart glasses for real-time processing tasks. Cloud-based speech-to-text systems provide the lowest Word Error Rate (WER), even under low-latency, real-time conditions, but the reliability of cellular or Wi-Fi connections can vary greatly depending on the smartphone hardware technology, each user's system settings and applications, the geographical location of the user, and other environmental factors.

### SUMMARY

The present invention introduces an integrated system of extended reality (XR) eyewear coupled with a dedicated, computational eyewear case, to address these shortcomings. A typical user stores their eyewear in a protective case when not in use. The physical size of such a case provides an opportunity to house additional hardware dedicated to supporting the functions of XR eyewear. A companion device in the form of an eyeglasses case can accommodate computational capabilities and wireless communication antennas, including cellular. Instead of offloading processing and communication tasks to a smartphone, this invention utilizes a dedicated, single-function computational case with specialized hardware, optimized for the functions of captioning glasses. The computational case is powerful enough to run a real-time, large vocabulary speech-to-text system, while dedicated wireless antennas provide reliable and consistent connections to Wi-Fi or cellular services for cloud processing. The physical size of the case leaves ample room for a large-capacity rechargeable battery. Whether or not the eyewear can itself contain some or all of the processing capabilities needed to execute the functions discussed herein, the additional resources and capabilities of the companion device of the present invention augment and expand the computational capabilities.

Some people who wear hearing aids, cochlear implant processors, or other assistive hearing devices use remote microphones that they place closer to the person or sound that they wish to hear better. These remote microphones wirelessly transmit the audio they capture right into the person's assistive hearing devices. Given this is a useful feature and existing user behavior, this proposed invention integrates one or more microphones into the computational eyewear case, allowing the computational case to also double as a remote microphone. The computational case can be used as both a remote microphone input into the speech-to-text system and a remote microphone accessory that pairs with assistive hearing devices. In addition, the computational case microphone(s) may be used to capture the acoustic noise profile of the environment as an input into noise reduction pre-processors that can improve the accuracy of speech-to-text systems.

Additionally, for instances where offloading processing tasks from the eyewear device is the implementation, this significantly simplifies the design and manufacturing of the eyewear device itself. This simplification can lead to a reduction in production costs, which can be beneficial both to manufacturers and consumers. Moreover, by reducing the number of integrated components within the eyewear, the overall size and weight of the glasses can be minimized. This reduction in size and weight enhances the comfort of the glasses, making them more wearable for extended periods. The resulting design of the eyewear, devoid of cumbersome internal processing hardware, also paves the way for a more aesthetically pleasing and user-friendly product, fostering broader acceptance and adoption of this solution.

Critical to optimizing the accuracy and WER of the captions, the primary feature of the XR eyewear in this invention is a multi-sensor microphone array that significantly improves the signal-to-noise ratio, thereby enhancing the accuracy of the speech-to-text systems. The microphone array in this invention is tuned to capture environmental sounds and voices other than the wearer's, a departure from conventional XR eyewear that primarily focuses on capturing the wearer's voice while suppressing environmental sounds. Additionally, a smart sensor integrated into the nose bridge of the eyewear detects when the wearer is speaking, which can be utilized to suppress captioning of the wearer's own voice, preventing any distraction or confusion, while potentially improving battery life by not processing the user's own voice.

The user-centric design of the captioning glasses system described in this invention emphasizes simplicity and reliability. The eyewear and companion case in the system are pre-paired together out of the box. The user simply puts the glasses on, powers on the glasses (whether the user pushes a button or there is another trigger that automatically powers on the glasses by the user putting on the glasses), and immediately begins to see captions of other people talking. The coupling of the XR eyewear with the computational case embodies a holistic, user-friendly, and effective solution that leverages sight for sound, either to enhance or completely restore speech comprehension for individuals with hearing challenges, offering a simple, reliable, and efficient assistive technology.

In accordance with example embodiments of the present invention, an integrated system for providing real-time speech-to-text captioning is presented. The system includes an eyewear component and an eyewear case component.

The eyewear component includes an eyewear frame, one or more microphones disposed in the eyewear frame and configured to capture audio, a sensor disposed in the eyewear frame to detect when a wearer is speaking, a display system disposed in the eyewear frame configured to project text and other information into the wearer's field of view, a wireless transceiver disposed in the eyewear frame, and a processor disposed in the eyewear frame and in communication with the one or more microphones, sensor, display system, and wireless transceiver. The processor is configured to receive audio from the one or more microphones; determine, using the sensor, if received audio is from the wearer speaking; transmit audio data for audio determined not to be from the wearer to an eyewear case component for speech-to-text conversion using wireless transceiver; receive, using the wireless transceiver, a speech-to-text conversion from the eyewear case component; and render, using the display system, the speech-to-text conversion in the wearer's field of view.

The eyewear case component includes a case housing, a wireless transceiver, at least one microphone; and a processor in communication with the wireless transceiver and the at least one microphone. The processor is configured to receive audio from the at least one microphone; receive, using the wireless transceiver, audio data from the eyewear component; perform speech-to-text conversion on the received audio data comprised of audio data from the eyewear component and/or audio from the at least one microphone of the eyewear case component to generate text data; and transmit the text data to the eyewear component.

In accordance with aspects of the present invention, the one or more microphones disposed in the eyewear frame comprise an array.

In accordance with aspects of the present invention, the sensor disposed in the eyewear frame employs audio, haptic, or other types of data to detect when the wearer is speaking.

In accordance with aspects of the present invention, the processor of the eyewear case component performs speech-to-text conversion by using a local large vocabulary speech-to-text model on the received audio data.

In accordance with aspects of the present invention, the processor of the eyewear case component performs speech-to-text conversion by providing, using the wireless transceiver, the received audio data to a remote cloud server; and receiving, using the wireless transceiver, the text data from the remote cloud server.

In accordance with aspects of the present invention, the processor of the eyewear case component is further configured to transmit, using the wireless transceiver, the audio data received from the at least one microphone of the eyewear case component to an assistive hearing device.

In accordance with aspects of the present invention, the processor of the eyewear case component is further configured to distinguish between speech and environmental noise in the received audio data. In still further aspects, the processor of the eyewear case component is further configured to use the audio data received from the one or more microphones of the eyewear case component to capture an acoustic noise profile of an environment and use this audio data is as an input into noise reduction pre-processors to improve accuracy of speech-to-text conversion.

In accordance with aspects of the present invention, audio determined to be from the wearer speaking is used for voice input for the system.

In accordance with aspects of the present invention, audio determined to be from the wearer speaking is used as a voice input for another device connected wirelessly.

In accordance with aspects of the present invention, the speech-to-text conversion involves a translation of speech from one language into text of a different language.

In accordance with aspects of the present invention, the speech-to-text conversion captures and represents additional characteristics and information from a received audible voice, including inflections, emphasis, emotional valence, and recognized voices.

In accordance with aspects of the present invention, audio-to-text conversion comprising labeling for audio that is not speech is provided for audio data.

In accordance with aspects of the present invention, a real-time audio volume level is rendered on the display as a level meter, indicating a volume of the wearer as captured by the one or more microphones of the eyewear component. In some such aspects, the level meter indicates when the wearer is speaking too quietly or too loudly, where the at least one microphone of the eyewear case component receives and measures an ambient sound level as an input into the level meter.

In accordance with aspects of the present invention, the wireless transceiver of the eyewear component is a short-range wireless transceiver.

In accordance with aspects of the present invention, the wireless transceiver of the eyewear case component is a cellular transceiver.

In accordance with example embodiments of the present invention, a method of providing speech-to-text conversion is presented. The method involves providing an integrated system as described herein; receiving, by the processor of the eyewear component, audio on the one or more microphones of the eyewear component; determining, by the processor of the eyewear component using the sensor of the eyewear component, if received audio is from the wearer speaking; transmitting, by the processor of the eyewear component using wireless transceiver of the eyewear component, audio data for audio determined not to be from the wearer to an eyewear case component; receiving, by the processor of the eyewear case component, audio data from the at least one microphone of the eyewear case component; receiving, by the processor of the eyewear case component using the wireless transceiver of the eyewear case component, audio data from the eyewear component; performing, by the processor of the eyewear case component, speech-to-text conversion on the received audio data comprised of audio data from the eyewear component and/or audio from the at least one microphone of the eyewear case component to generate text data; transmitting, by the processor of the eyewear case component using the wireless transceiver of the eyewear case component, the text data to the eyewear component; receiving, by the processor of the eyewear component using the wireless transceiver of the eyewear component, a text data from the eyewear case component; and rendering, by the processor of the eyewear component using the display system of the eyewear component, the text data in the wearer's field of view.

In accordance with aspects of the present invention, the one or more microphones disposed in the eyewear frame comprise an array.

In accordance with aspects of the present invention, the sensor disposed in the eyewear frame employs audio, haptic, or other types of data to detect when the wearer is speaking.

In accordance with aspects of the present invention, performing, by the processor of the eyewear case component, speech-to-text conversion on the received audio data comprised of audio data from the eyewear component and/or audio from the at least one microphone of the eyewear case component to generate text data processor of the eyewear case component comprises using a local large vocabulary speech-to-text model on the received audio data.

In accordance with aspects of the present invention, performing, by the processor of the eyewear case component, speech-to-text conversion on the received audio data comprised of audio data from the eyewear component and/or audio from the at least one microphone of the eyewear case component to generate text data processor of the eyewear case component involves providing, using the wireless transceiver of the wireless transceiver of the eyewear case component, the received audio data to a remote cloud server; and receiving, using the wireless transceiver of the wireless transceiver of the eyewear case component, the text data from the remote cloud server.

In accordance with aspects of the present invention, the method further involves transmitting, by the processor of the eyewear case component using the wireless transceiver of the eyewear case component, the audio data received from the at least one microphone of the eyewear case component to an assistive hearing device.

In accordance with aspects of the present invention, the method further involves distinguishing, by the processor of the eyewear case component, between speech and environmental noise in the received audio data. In certain aspects, distinguishing between speech and environmental noise involves the processor of the eyewear case component using the audio data received from the one or more microphones of the eyewear case component to capture an acoustic noise profile of an environment and using this audio data is as an input into noise reduction pre-processors to improve accuracy of speech-to-text conversion.

In accordance with aspects of the present invention, the speech-to-text conversion comprises a translation of speech from one language into text of a different language.

In accordance with aspects of the present invention, audio-to-text conversion comprising labeling for audio that is not speech is provided for audio data.

### BRIEF DESCRIPTION OF THE FIGURES

These and other characteristics of the present invention will be more fully understood by reference to the following detailed description in conjunction with the attached drawings, in which:

FIG. 1 shows the XR eyewear and computational case devices in the system, in the context of the user experience;

FIG. 2 shows the components of the XR eyewear device;

FIG. 3 shows the components of the computational eyewear case;

FIG. 4 is a high level flow diagram for a method of providing speech-to-text conversion using the device; and

FIG. 5 is a diagrammatic illustration of a high-level architecture configured for implementing processes in accordance with aspects of the invention.

### DETAILED DESCRIPTION

An illustrative embodiment of the present invention relates to an integrated system of XR eyewear coupled with a dedicated, computational eyewear case. Instead of offloading processing and communication tasks to a smartphone, this invention utilizes a dedicated, single-function computational case, optimized for the functions of captioning glasses. The computational case is powerful enough to run a real-time, large vocabulary speech-to-text system, while dedicated wireless antennas provide reliable and consistent connections to Wi-Fi or cellular services for cloud processing.

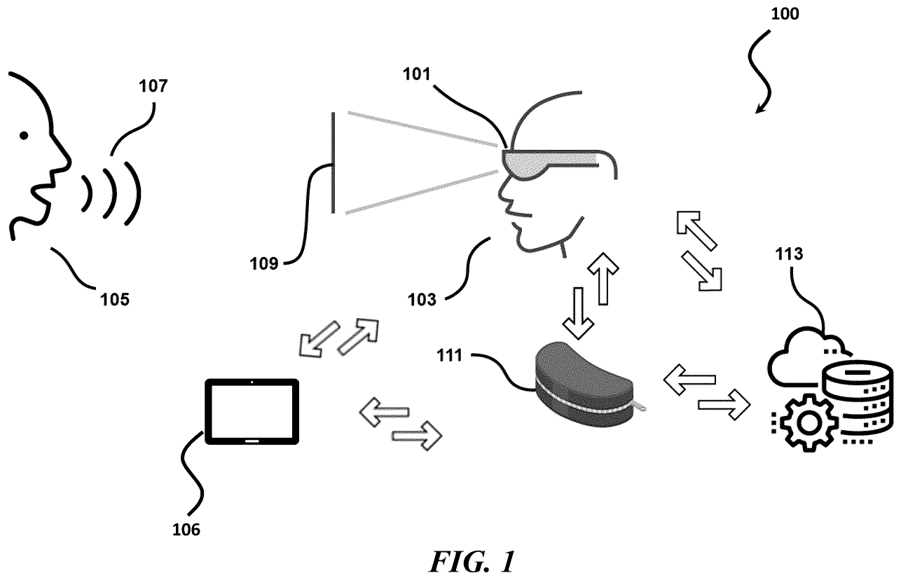

FIGS. 1 through FIG. 5 wherein like parts are designated by like reference numerals throughout, illustrate an example embodiment or embodiments of an integrated system for providing real-time speech-to-text captioning, according to the present invention. Although the present invention will be described with reference to the example embodiment or embodiments illustrated in the figures, it should be understood that many alternative forms can embody the present invention. One of skill in the art will additionally appreciate different ways to alter the parameters of the embodiment(s) disclosed, such as the size, shape, or type of elements or materials, in a manner still in keeping with the spirit and scope of the present invention.

As seen in FIG. 1, The present invention is directed to a system 100 that includes an eyewear component 101 and an eyewear case component 111. The eyewear component is an extended reality (XR) eyewear component 101, worn by a user 103, where the eyewear component 101 captures speech 107 from another person 105 and renders the speech 107 into a real-time caption display 109 projected into the intermediate field of view of the wearer 103. The eyewear component 101 may be wirelessly coupled with the eyewear case component 111. The computational eyewear case component 111 provides real-time data transfer, analysis, and processing. Both the eyewear component 101 and the eyewear case component 111 may also wirelessly connect to a remote server or servers 113 for real-time data transfer, analysis, and processing. In still other embodiments, the eyewear component 101 and the eyewear case component 111 may also wirelessly connect an additional device 106 that can be used to receive and transmit input to the eyewear component 101 and/or the eyewear case component 111 as well as receive data, such as real-time captions, from the eyewear component 101 and/or the eyewear case component 111 that can be displayed or otherwise outputted on the device 106.

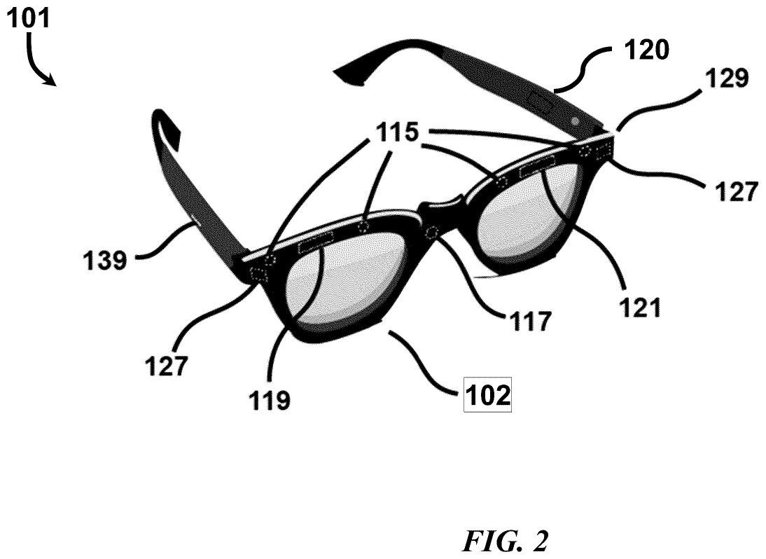

As shown in FIG. 2, the eyewear component 101 comprises a frame 102, one or more microphones 115, a sensor 117, a processor 119, a wireless transceiver 120, and a display system 127.

The one or more microphones 115 are disposed in the frame 102 and configured to capture audio. In certain embodiments, the frame 102 includes at least two (2) microphones 115, in any configuration (e.g. broadside, endfire) to capture speech 107 from another person 105. In some such embodiments, the one or more microphones 115 comprise an array.

The sensor 117 is disposed in the frame 102 to detect when the wearer 103 of the eyewear component 101 is speaking. The sensor 117 may employ audio, haptic, or other types of data to detect when the wearer 103 is speaking. For example, the sensor 117 may be a microphone or vibration sensor. (e.g., microphone, vibration) integrated into the frame 102.

In this embodiment, the sensor 117 is located at the nose bridge. This sensor data may be used as an input into the speech-to-text conversion process, to optionally suppress the conversion and rendering of the user's own voice. In still other embodiments, this sensor 117 can be used to detect when the eyewear component 101 is being worn by the wearer 103 and automatically power on the eyewear component 101. Similarly, the sensor can be used to detect when the eyewear component 101 is no longer being worn and automatically turn of the eyewear component 101.

These one or more microphones 115 and sensor 117 connect to a computational and communication system including the processor 119 and a wireless transceiver 120 disposed in the frame 102 to detect if the user 103, in this case the wearer, is speaking, provide analog-to-digital conversion, digital signal processing, and wireless communication capabilities. The processor 119 may analyze and process received data (including speech-to-text processing) and/or route the data via wireless communications protocols (e.g., Bluetooth, Wi-Fi) using the wireless transceiver 120 to a remote server 113, or to the companion eyewear case 111.

The wireless transceiver 120 can comprise or otherwise include a short-range wireless transceiver that utilizes a short-range communication protocol such as Bluetooth or Wi-Fi. In other embodiments, the wireless transceiver 120 comprises or otherwise includes a cellular transceiver.

The display system 127 may make use of a waveguide, micro LED, LCOS, LCD, or OLED display placed in the wearer's 103 field of view, a projector projecting an image on lenses disposed in the eyewear component 101, image reflection techniques known in the art, or any combination of technologies used for displaying information in the field of augmented reality.

In some embodiments, the frame 102 of the eyewear component 101 further includes a battery 121 to provide power. In still other embodiments, a multi-purpose button 139 is used to power the device on and off as well as perform other functions during operation.

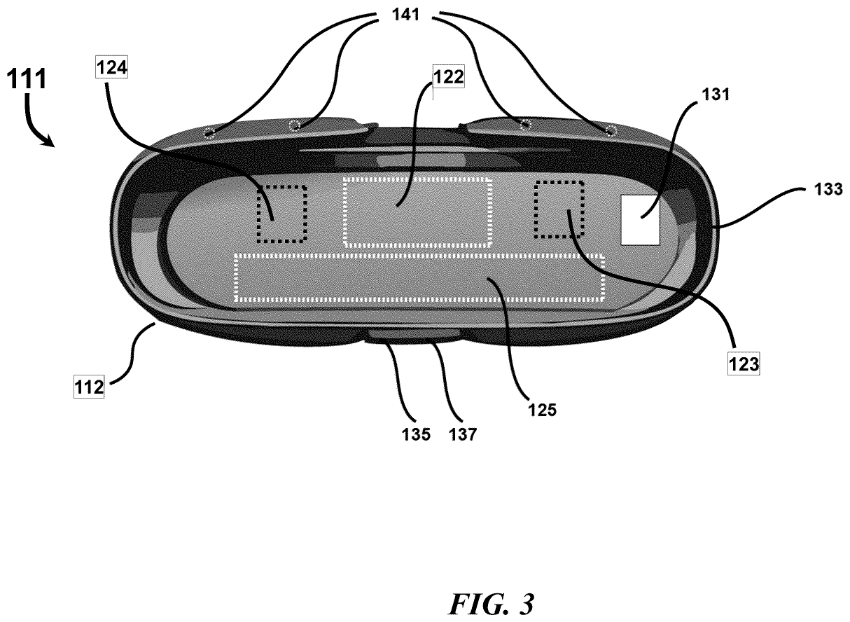

As shown in FIG. 3 the computation eyewear case 111 comprises a housing 112, a processor 122, a wireless transceiver 123, and at least one microphone 141.

The computational eyewear case 111 includes a computational and communication system that includes the processor 122, wireless transceiver 123, and memory storage 124 provides the functionality for digital signal processing, wireless communication (e.g., Bluetooth, Wi-Fi, and cellular), large vocabulary speech-to-text models, and analog-to-digital converter. In certain embodiments, the case 111 includes a large capacity rechargeable battery and power management component 125 providing power.

The computational eyewear case 111 pairs securely with the XR eyewear device 101 via wireless communication protocols (e.g., Bluetooth, Direct Wi-Fi) via the wireless transceivers 120, 123, and when functioning together as a real-time system 100, the eyewear device 101 transmits audio data to the computational eyewear case 111. The processor 122 of the case 111 can then perform speech-to-text conversion on the received audio data. In certain embodiments, the processor 122 may route the eyewear audio data through its local large vocabulary speech-to-text model to transcribe digital audio speech data into text data.

The wireless transceiver 123 can comprise or otherwise include a short-range wireless transceiver that utilizes a short-range communication protocol such as Bluetooth or Wi-Fi. In other embodiments, the wireless transceiver 123 comprises or otherwise includes a cellular transceiver.

If the case 111 can connect to a remote cloud server 113, the case may instead route or otherwise transmit the eyewear audio data, using the transceiver 123, to the remote cloud server 113 for processing and speech-to-text conversion and receive back, via the transceiver 123, text data from the remote server 113. Similarly, if the eyewear device 101 can connect to a remote cloud server 113, then the eyewear device 101 may instead route or transmit its audio data directly, using the wireless transceiver 120, to the remote cloud server 113 for processing and speech-to-text conversion and receive back, via the transceiver 123, text data from the remote server 113.

Whether the speech-to-text conversion process occurs in the eyewear device 101, the computational case 111, or on a remote cloud server 113, text and other metadata generated from the speech-to-text conversion process (including speaker diarisation, inflection analysis, emphasis analysis, emotion valence analysis, sentiment analysis, speaker location, voice recognition, etc.) is provided to the eyewear device 101. In the examples where the computational case 111, or remote cloud server 113 does the processing the text and other metadata is transmitted back to the eyewear device 101 through established wireless protocols using the wireless transceivers 120, 123. The eyewear device processor 119 receives, analyzes, processes, and renders text and other relevant information to a monocular or binocular XR display system or systems 127. Each display system 127 may use any appropriate method to create an optical see-thru display 109 capable of projecting text and other information in such a manner that the wearer 103 can view the text information at an intermediate distance.

A single microphone or a plurality of microphones 141 are integrated into the computational case 111. In certain embodiments, where there are multiple microphones 141, they can be arranged as an array in any geometry and connected to the analog-to-digital converters in the case system processor 122.

In accordance with embodiments of the present invention, the case microphone 141 connected with the case system processor 122 may be used as a remote microphone, in which the user 103 may position the case 111 nearer to the person 105 they wish to capture, and the speech 107 captured from the case microphones 141 will be transmitted into the speech-to-text system, whether in the case system processor 122, or wirelessly to a cloud server 113.

In accordance with embodiments of the present invention, the case 111 may be used as a remote microphone accessory for hearing aids, cochlear implants, or any other such assistive hearing device. In this embodiment, the digitized and processed audio signal is wirelessly transmitted from the case system processor 122 directly into the user's 103 assistive hearing device.

In accordance with embodiments of the present invention, the user 103 may use the case as a remote microphone for the simultaneous benefit of speech-to-text processing for this invention, and as an input to the user's 103 other assistive hearing devices.

In accordance with embodiments of the present invention, the case microphones 141 connected with the case system processor 122 may be used to capture the ambient acoustic noise of the environment. This data can be used as a pre-processing step to distinguish between speech and environmental noise. In certain embodiments, this involves capturing the acoustic noise profile of the environment and using this audio data as an input into noise reduction pre-processors to reduce background noise to improve accuracy prior to transmitting the digitized speech signal to the speech-to-text system. In this embodiment, the pre-processing step may be performed either in the case system processor 122, transmitted via wireless communication to the eyewear device processor 119, or to a remote cloud server 113.

In other embodiments, the case system processor 122 can transmit speech-to-text captioning to one or more additional devices 106 such as smartphones, tablets, computers, or displays using the wireless transceiver 123. The device(s) 106 may then display or otherwise output the speech-to-text captioning. Alternatively, the device 106 may be used to provide input to the computational case 111.

When the eyewear device 101 is stored in the computational case 111, a magnetic charging mechanism 129 on the eyewear device 101 couples with a charging mechanism 131 in the computational case 111, and the case power management system 125 may recharge the eyewear battery 121.

Alternatively, eyewear device 101 may be provided with an additional charging mechanism such as a USB-C port for charging the eyewear battery 121.

External to the eyewear case is a charging port 133, which may be a USB-C connector, or equivalent, a multi-purpose action button 135, and an LED status indicator 137. The eyewear case battery case power management system 125 may recharge when the case is connected to a power source via the external charging port 133.

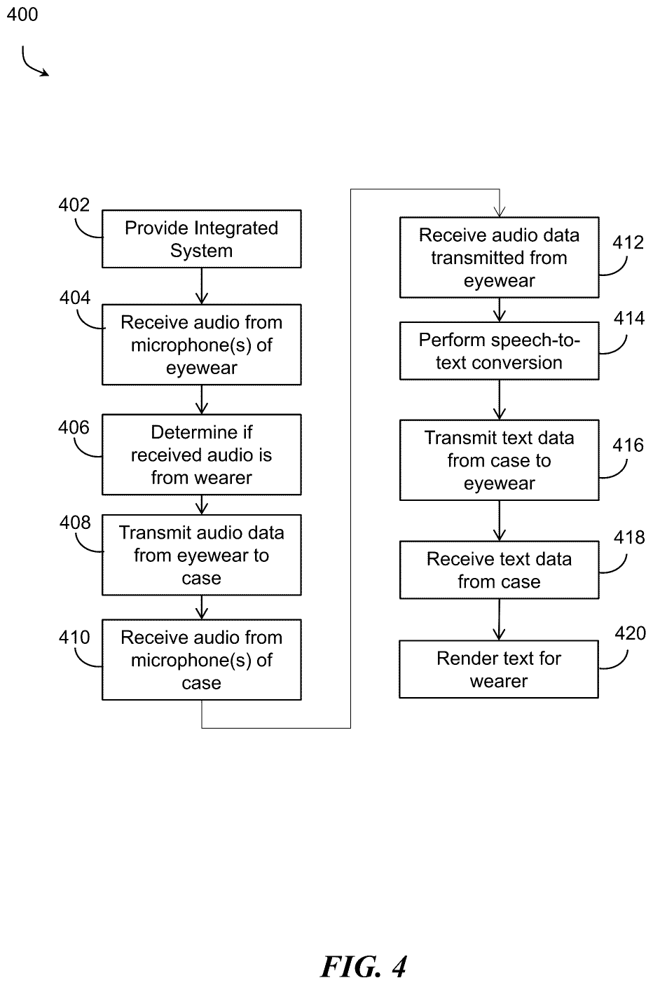

FIG. 4 is a high-level flow diagram 400 depicting how the system 100 can be used to provide speech-to-text conversion. First, an integrated system 100 comprising the eyewear component 101 and the eyewear component case 111 as disclosed herein is provided to a user 103 (step 402) wherein the eyewear component 101 is worn by the user 103. Audio is received by the processor 119 of the eyewear component 101 on one or more microphones 115 of the eyewear component 101 (step 404). The processor 119 of the eyewear component 101 determines, using the sensor 117 of the eyewear component 101, when/if the received audio is from the wearer 103 speaking (step 406). The processor 119 of the eyewear component 101 may then determine the available means of providing speech-to text processing. The processing can be performed by the processor 119 or offloaded to the eyewear case component 111 or remote cloud server 113. In the example where the component case 11 is utilized, the processor 119 transmits, using the wireless transceiver 120 of the eyewear component 101, audio data for audio determined not to be the wearer 103 speaking to the eyewear component case 111 (step 408). At the eyewear component case 111, the processor 122 receives audio data from the at least one microphone 141 of the eyewear case component 111 (step 410). The processor 122 also receives, using the wireless transceiver 123 of the eyewear case component 111, the audio data from the eyewear component 101 (step 412). The processor 122 of the eyewear case component 111 then performs speech-to-text conversion on the received audio data comprised of audio data from the eyewear component 101 and/or audio from the at least one microphone 141 of the eyewear case component 111 to generate text data (step 414). The processor 122 then transmits, using the wireless transceiver 123, the text data back to the eyewear component 101 (step 416). At the eyewear component, the processor 119 receives the text data via the wireless transceiver 120 (step 418) and renders, using the display system 127, the text in the wearer's field of view (step 420).

In certain embodiments, audio determined to be from the wearer (user 103) of the eyewear component 101 speaking, can be used as a voice input for another device connected wirelessly to the system 100.

In certain embodiments, the user 103 may change the text output language setting independently from the input audio language setting, allowing the system 100 to be used to translate speech from one language into text of one or more different language.

In certain embodiments, the system 100 may also provide audio-to-text transcription wherein audio data that is not speech may also be labeled or otherwise identified via text identifiers similar to audio for the hearing-impaired functionality provided for movies and television.

In certain embodiments, a volume level meter or other indication is rendered on the display 109. For example, the rendered volume on the rendered display 109 may indicate the volume of the wearer's (user 103) speech as detected. In some cases, this may further indicate the wearer's (user 103) volume in comparison to the other audible person(s) 105 speaking as detected. Such indication can let the wearer (user 103) know that they are speaking too loud or too quiet in comparison to other speakers or the measured ambient sound level.

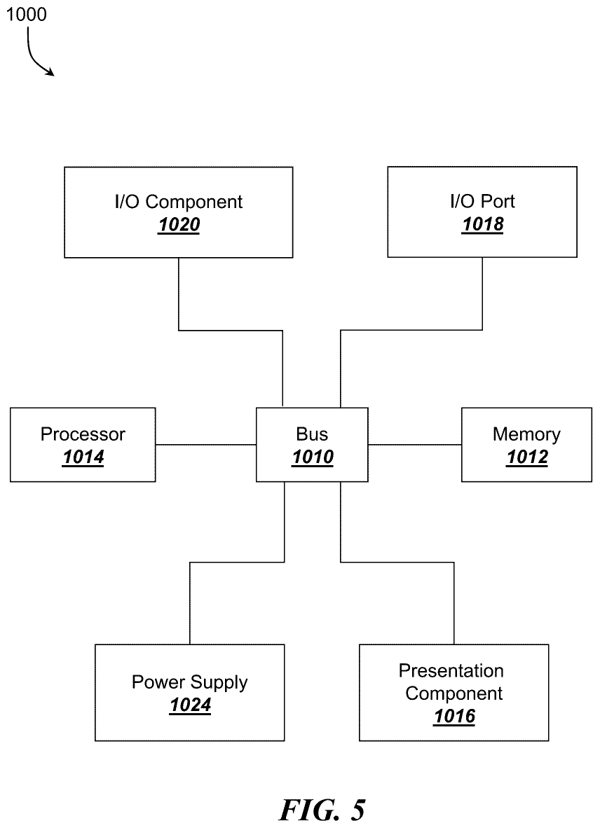

One illustrative example of a computing device 1000 used to provide the functionality of the present invention, such as provided by the eyewear 101 and/or case 111 of the system 100 or connected remote cloud server 113, is depicted in FIG. 5. The computing device 1000 is merely an illustrative example of a suitable special purpose computing environment and in no way limits the scope of the present invention. A “computing device,” as represented by FIG. 5, can include a “workstation,” a “server,” a “laptop,” a “desktop,” a “hand-held device,” a “mobile device,” a “tablet computer,” or other computing devices, as would be understood by those of skill in the art. Given that the computing device 1000 is depicted for illustrative purposes, embodiments of the present invention may utilize any number of computing devices 1000 in any number of different ways to implement a single embodiment of the present invention. Accordingly, embodiments of the present invention are not limited to a single computing device 1000, as would be appreciated by one with skill in the art, nor are they limited to a single type of implementation or configuration of the example computing device 1000.

The computing device 1000 can include a bus 1010 that can be coupled to one or more of the following illustrative components, directly or indirectly: a memory 1012, one or more processors 1014, one or more presentation components 1016, input/output ports 1018, input/output components 1020, and a power supply 1024. One of skill in the art will appreciate that the bus 1010 can include one or more busses, such as an address bus, a data bus, or any combination thereof. One of skill in the art additionally will appreciate that, depending on the intended applications and uses of a particular embodiment, multiple of these components can be implemented by a single device. Similarly, in some instances, a single component can be implemented by multiple devices. As such, FIG. 5 is merely illustrative of an exemplary computing device that can be used to implement one or more embodiments of the present invention, and in no way limits the invention.

The computing device 1000 can include or interact with a variety of computer-readable media. For example, computer-readable media can include Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices that can be used to encode information and can be accessed by the computing device 1000.

The memory 1012 can include computer-storage media in the form of volatile and/or nonvolatile memory. The memory 1012 may be removable, non-removable, or any combination thereof. Exemplary hardware devices are devices such as hard drives, solid-state memory, optical disc drives, and the like. The computing device 1000 can include one or more processors 1014 (such as processor 119, 122) that read data from components such as the memory 1012, the various I/O components 1016, etc. Presentation component(s) 1016 present data indications to a user or other device. Exemplary presentation components include a display device (such as displayl 14), speaker, printing component, vibrating component, etc.

The I/O ports 1018 can enable the computing device 1000 to be logically coupled to other devices, such as I/O components 1020. Some of the I/O components 1020 can be built into the computing device 1000. Examples of such I/O components 1020 include a microphone (such as microphones 115, 141), joystick, recording device, game pad, satellite dish, scanner, printer, wireless device, networking device, and the like.

The power supply 1024 can include batteries (such as a lithium-ion battery 121). Other suitable power supply or batteries will be apparent to one skilled in the art given the benefit of this disclosure.

The disclosed integrated system of the present invention provides real-time or close to real-time transcription of audio including spoken language and/or other audio into texts including translation of spoken language into text in multiple languages.

As utilized herein, the terms “comprises” and “comprising” are intended to be construed as being inclusive, not exclusive. As utilized herein, the terms “exemplary”, “example”, and “illustrative”, are intended to mean “serving as an example, instance, or illustration” and should not be construed as indicating, or not indicating, a preferred or advantageous configuration relative to other configurations. As utilized herein, the terms “about”, “generally”, and “approximately” are intended to cover variations that may exist in the upper and lower limits of the ranges of subjective or objective values, such as variations in properties, parameters, sizes, and dimensions. In one non-limiting example, the terms “about”, “generally”, and “approximately” mean at, or plus 10 percent or less, or minus 10 percent or less. In one non-limiting example, the terms “about”, “generally”, and “approximately” mean sufficiently close to be deemed by one of skill in the art in the relevant field to be included. As utilized herein, the term “substantially” refers to the complete or nearly complete extent or degree of an action, characteristic, property, state, structure, item, or result, as would be appreciated by one of skill in the art. For example, an object that is “substantially” circular would mean that the object is either completely a circle to mathematically determinable limits, or nearly a circle as would be recognized or understood by one of skill in the art. The exact allowable degree of deviation from absolute completeness may in some instances depend on the specific context. However, in general, the nearness of completion will be so as to have the same overall result as if absolute and total completion were achieved or obtained. The use of “substantially” is equally applicable when utilized in a negative connotation to refer to the complete or near complete lack of an action, characteristic, property, state, structure, item, or result, as would be appreciated by one of skill in the art.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. Within this specification, embodiments have been described in a way that enables a clear and concise specification to be written, but it is intended and will be appreciated that embodiments may be variously combined or separated without parting from the invention. It is intended that the present invention be limited only to the extent required by the appended claims and the applicable rules of law.

It is also to be understood that the following claims are to cover all generic and specific features of the invention described herein, and all statements of the scope of the invention which, as a matter of language, might be said to fall therebetween.

What is claimed is:

1. An integrated system for providing real-time speech-to-text captioning, comprising:
an eyewear component, comprising:
an eyewear frame;
one or more microphones disposed in the eyewear frame and configured to capture audio;
a sensor disposed in the eyewear frame to detect when a wearer is speaking;
a display system disposed in the eyewear frame configured to project text and other information into the wearer's field of view;
a wireless transceiver disposed in the eyewear frame; and
a processor disposed in the eyewear frame and in communication with the one or more microphones, sensor, display system, and wireless transceiver, the processor configured to:
receive audio from the one or more microphones;
determine, using the sensor, if received audio is from the wearer speaking;
transmit audio data for audio determined not to be from the wearer to an eyewear case component for speech-to-text conversion using wireless transceiver;
receive, using the wireless transceiver, a speech-to-text conversion from the eyewear case component; and
render, using the display system, the speech-to-text conversion in the wearer's field of view; and
the eyewear case component, comprising:
a case housing;
a wireless transceiver;
at least one microphone; and
a processor in communication with the wireless transceiver and the at least one microphone, the processor configured to:
receive audio from the at least one microphone;
receive, using the wireless transceiver, audio data from the eyewear component;
perform speech-to-text conversion on the received audio data comprised of audio data from the eyewear component and/or audio from the at least one microphone of the eyewear case component to generate text data; and
transmit the text data to the eyewear component.

2. The system of claim 1, wherein the one or more microphones disposed in the eyewear frame comprise an array.

3. The system of claim 1, wherein the sensor disposed in the eyewear frame employs audio, haptic, or other types of data to detect when the wearer is speaking.

4. The system of claim 1, wherein the sensor disposed in the eyewear frame is further configured to detect when the eyewear frame is being worn.

5. The system of claim 1, wherein the processor of the eyewear case component performs speech-to-text conversion by using a local large vocabulary speech-to-text model on the received audio data.

6. The system of claim 1, wherein the processor of the eyewear case component performs speech-to-text conversion by:
providing, using the wireless transceiver, the received audio data to a remote cloud server; and
receiving, using the wireless transceiver, the text data from the remote cloud server.

7. The system of claim 1, wherein the processor of the eyewear case component is further configured to:
transmit, using the wireless transceiver, the audio data received from the at least one microphone of the eyewear case component to an assistive hearing device.

8. The system of claim 1, wherein the processor of the eyewear case component is further configured to distinguish between speech and environmental noise in the received audio data.

9. The system of claim 8, wherein the processor of the eyewear case component is further configured to use the audio data received from the one or more microphones of the eyewear case component to capture an acoustic noise profile of an environment and use this audio data is as an input into noise reduction pre-processors to improve accuracy of speech-to-text conversion.

10. The system of claim 1, wherein the processor of the eyewear case component is further configured to:
transmit, using the wireless transceiver, the text data to a device.

11. The system of claim 1, wherein the processor of the eyewear case component is further configured to:
receive, using the wireless transceiver, data from a device.

12. The system of claim 1, where audio determined to be from the wearer speaking is used for voice input for the system.

13. The system of claim 1, where audio determined to be from the wearer speaking is used as a voice input for another device connected wirelessly.

14. The system of claim 1, wherein the speech-to-text conversion comprises a translation of speech from one language into text of a different language.

15. The system of claim 1, wherein the speech-to-text conversion captures and represents additional characteristics and information from a received audible voice, comprising inflections, emphasis, emotional valence, and recognized voices.

16. The system of claim 1, wherein audio-to-text conversion comprising labeling for audio that is not speech is provided for audio data.

17. The system of claim 1, wherein a real-time audio volume level is rendered on the display as a level meter, indicating a volume of the wearer as captured by the one or more microphones of the eyewear component.

18. The system of claim 17, wherein the level meter indicates when the wearer is speaking too quietly or too loudly, where the at least one microphone of the eyewear case component receives and measures an ambient sound level as an input into the level meter.

19. The system of claim 1, wherein the wireless transceiver of the eyewear component comprises a short-range wireless transceiver.

20. The system of claim 1, wherein the wireless transceiver of the eyewear case component comprises a cellular transceiver.

21. A method of providing speech-to-text conversion, the method comprising:
providing an integrated system comprising:
an eyewear component, comprising:
an eyewear frame;
one or more microphones disposed in the eyewear frame and configured to capture audio;
a sensor disposed in the eyewear frame to detect when a wearer is speaking;
a display system disposed in the eyewear frame configured to project text and other information into the wearer's field of view;
a wireless transceiver disposed in the eyewear frame; and
a processor disposed in the eyewear frame and in communication with the one or more microphones, sensor, display system, and wireless transceiver, the processor configured to:
receive audio from the one or more microphones;
determine, using the sensor, if received audio is from the wearer speaking;
transmit audio data for audio determined not to be from the wearer to an eyewear case component for speech-to-text conversion using wireless transceiver;
receive, using the wireless transceiver, a speech-to-text conversion from the eyewear case component; and
render, using the display system, the speech-to-text conversion in the wearer's field of view; and
the eyewear case component, comprising:
a case housing;
a wireless transceiver;
at least one microphone; and
a processor in communication with the wireless transceiver and the at least one microphone, the processor configured to:
receive audio from the at least one microphone;
receive, using the wireless transceiver, audio data from the eyewear component;
perform speech-to-text conversion on the received audio data comprised of audio data from the eyewear component and/or audio from the at least one microphone of the eyewear case component to generate text data; and
transmit the text data to the eyewear component;
receiving, by the processor of the eyewear component, audio on the one or more microphones of the eyewear component;
determining, by the processor of the eyewear component using the sensor of the eyewear component, if received audio is from the wearer speaking;
transmitting, by the processor of the eyewear component using wireless transceiver of the eyewear component, audio data for audio determined not to be from the wearer to an eyewear case component;
receiving, by the processor of the eyewear case component, audio data from the at least one microphone of the eyewear case component;
receiving, by the processor of the eyewear case component using the wireless transceiver of the eyewear case component, audio data from the eyewear component;
performing, by the processor of the eyewear case component, speech-to-text conversion on the received audio data comprised of audio data from the eyewear component and/or audio from the at least one microphone of the eyewear case component to generate text data;
transmitting, by the processor of the eyewear case component using the wireless transceiver of the eyewear case component, the text data to the eyewear component;
receiving, by the processor of the eyewear component using the wireless transceiver of the eyewear component, a text data from the eyewear case component; and
rendering, by the processor of the eyewear component using the display system of the eyewear component, the text data in the wearer's field of view.

22. The method of claim 21, wherein the one or more microphones disposed in the eyewear frame comprise an array.

23. The method of claim 21, wherein the sensor disposed in the eyewear frame employs audio, haptic, or other types of data to detect when the wearer is speaking.

24. The method of claim 21, wherein the sensor disposed in the eyewear frame is further configured to detect when the eyewear frame is being worn.

25. The method of claim 21, wherein performing, by the processor of the eyewear case component, speech-to-text conversion on the received audio data comprised of audio data from the eyewear component and/or audio from the at least one microphone of the eyewear case component to generate text data processor of the eyewear case component comprises using a local large vocabulary speech-to-text model on the received audio data.

26. The method of claim 21, wherein performing, by the processor of the eyewear case component, speech-to-text conversion on the received audio data comprised of audio data from the eyewear component and/or audio from the at least one microphone of the eyewear case component to generate text data processor of the eyewear case component comprises:
providing, using the wireless transceiver of the wireless transceiver of the eyewear case component, the received audio data to a remote cloud server; and
receiving, using the wireless transceiver of the wireless transceiver of the eyewear case component, the text data from the remote cloud server.

27. The method of claim 21, further comprising:
transmitting, by the processor of the eyewear case component using the wireless transceiver of the eyewear case component, the audio data received from the at least one microphone of the eyewear case component to an assistive hearing device.

28. The method of claim 21, further comprising:
distinguishing, by the processor of the eyewear case component, between speech and environmental noise in the received audio data.

29. The method of claim 28, wherein distinguishing between speech and environmental noise comprises:
the processor of the eyewear case component using the audio data received from the one or more microphones of the eyewear case component to capture an acoustic noise profile of an environment and using this audio data is as an input into noise reduction pre-processors to improve accuracy of speech-to-text conversion.

30. The method of claim 21, wherein the speech-to-text conversion comprises a translation of speech from one language into text of a different language.

31. The method of claim 21, wherein audio-to-text conversion comprising labeling for audio that is not speech is provided for audio data.

32. The method of claim 21, further comprising:
transmitting, using the wireless transceiver, the text data to a device.

33. The method of claim 21, further comprising:
receiving, using the wireless transceiver, data from a device.
